(19) United States
(12) Patent Application Publication
(10) Pub. No.: US 2007/0242317 A1
(43) Pub. Date: Oct. 18, 2007

(54) Alignment unit and image recording apparatus using same

(75) Inventors: Akihiro Hashiguchi, Kanagawa (JP); Hiroshi Uemura, Kanagawa (JP); Kazuhiro Terada, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM CORPORATION, Tokyo (JP)

(21) Appl. No.: 11/783,708

(22) Filed: Apr. 11, 2007

(30) Foreign Application Priority Data
Apr. 12, 2006 (JP) 2006-109461
Sep. 28, 2006 (JP) 2006-264370

(51) Int. Cl. H04N 1/04

(52) U.S. Cl. 358/474

(57) ABSTRACT

Disclosed is an image recording apparatus configured with: a first camera, mounted via a movement adjusting mechanism on one face side portion of a base member of an alignment unit for capturing a first mark provided on a recording medium; and a second camera, mounted via a movement adjusting mechanism on the other face side portion of the base member of the alignment unit for capturing the position of a second mark for positioning that, relative to the direction along the conveying direction, has been shifted by a predetermined small distance in the direction orthogonal to the conveying direction relative to the first mark provided on the recording medium. Further, an alignment unit that may be used in the apparatus is disclosed.

### CROSS-REFERENCE TO RELATED APPLICATION

This application claims priority under 35 U.S.C 119 from Japanese Patent Applications Nos. 2006-109461 and 2006-264370, the disclosure of which is incorporated by reference herein.

### BACKGROUND

1. Technical Field

This invention relates to an alignment unit including plural cameras, and to an image recording apparatus recording a predetermined pattern by performing a scanning operation, which is corrected by using the alignment unit for errors when a recording head and a recording stage having a recording medium mounted thereon are relatively moved while each beam emitted from a spatial modulator (2-dimensional optical modulator) or the like installed in the recording head, which is a means for selectively turning on/off plural pixels based on image data (pattern data), is focused on a pixel-by-pixel basis and irradiated onto the recording medium by optical elements.

2. Related Art

Generally, a flat bed image recording apparatus is used for exposing a recording medium that is, for example, a substrate for a printed wiring board (referred to as a PWB below) or a flat panel display (referred to as a FPD below).

In such a flat bed image recording apparatus, exposure processing is carried out by mounting a recording medium on a recording stage, and while moving the recording medium in the main scanning direction, by moving the recording stage along sliding rails placed on a surface table, a multibeam emitted from a light-source side is spatially modulated according to a modulation signal generated from image data from the recording head, and irradiated onto the recording medium.

In such a flat bed image recording apparatus, in order to raise the resolution, it is necessary to raise the precision of the scanning position of the light beams.

In conventional flat bed image recording apparatuses, for correcting the image recording position, marks for positioning, such as through holes, are provided in advance at plural predetermined positions on the recording medium (for example at the positions of the four corners of a rectangular shaped recording medium), and camera unit(s) are provided at the image recording apparatus side.

In such a flat bed image recording apparatus, there is a proposal that when the recording stage is moved in the outward direction, the marks for use in positioning of the recording medium are captured (photographed) by the camera unit while in a state in which the recording stage is moving, and by predicting the deformation of the marks for use in positioning generated by the movement velocity of the recording stage and the shutter speed of the image capture elements of the camera unit, even though the marks that are read in are deformed, the relative position of the recording medium and the recording head may be identified with certainty and the positional misalignment relative to the recording medium detected. In this proposal, after correction processing of the image recording position so as to correct for the detected positional misalignment, exposure processing is carried out, while moving the recording stage on the homeward path, by irradiating from the recording head a multibeam that has been spatially modulated, according to the position of the recording medium (see, for example, Japanese Patent Application Laid-Open (JP-A) No. 2005-132095).

In such a manner, in the image recording apparatus, when marks formed on the recording medium are captured by the camera unit and processing is carried out for correction of positional misalignment of the recording medium to the recording head, in order to detect the position of the marks for positioning with high precision (micron order precision), capturing is undertaken by high resolution camera units, the positional coordinates within the field of the cameras are specified and also, it is necessary to specify with high precision the equivalent positional coordinates of the camera units for capturing the marks for positioning provided on the recording medium on the recording stage.

Also, in such a image recording apparatus, sometimes the plural marks for positioning, provided in advance on a recording medium for carrying out correction processing of positional misalignment, are also used in the operation of setting the position of the recording medium on the recording stage as marks for discriminating between the front face/back face and top/bottom of the recording medium, and as marks for discriminating the facing direction of the front face of the recording medium.

In such a case, for example, when piercing through holes as respective marks for positioning at each of the predetermined positions of the four corners of a rectangular recording medium, through holes are pierced as marks for positioning at the position of three of the apexes of the four apexes of the square or rectangle, and the remaining mark for positioning is pierced at a predetermined shifted position, moved by a predetermined distance from the position of the apex along one of the sides of the square or rectangle.

In a recording medium with such a arrangement configuration of plural marks for positioning, if an operator, when holding a recording medium in their hands, mounts the recording medium to the recording stage in a state in which the mark for positioning that is in the predetermined shifted position is at a particular corner of the front-rear/left-right four corners (for example at the near left corner), then the recording medium may be mounted on the recording stage in the correct setting state with the front face of the recording medium (the recording face) to the top and the back edge of the recording medium at the back side of the recording stage.

However, when there is such a configuration of a through hole of one of the marks for positioning shifted from the position of the apex of the square or rectangle, then the placement range of a camera unit for detecting a mark for positioning that is over a position of the apex of the square or rectangle, and the placement range of a camera unit for detecting the mark for positioning that is over a position that is shifted, in a direction orthogonal to the conveying direction of the recording stage relative to the marks for positioning over the apexes, overlap each other, and there is the problem that sometimes in the image recording apparatus it is not possible to install the camera unit for detecting the shifted mark for positioning.

Furthermore, there is also the problem that, depending on the position of the marks, due to restrictions on the physical placement arrangement arising from the camera body size and the like it may become difficult to read a mark position in the direction that is orthogonal to the conveying direction of the recording stage.

### SUMMARY

The present invention is made in the light of the above circumstances and provides a new alignment unit and image recording apparatus using the alignment unit, with which it is possible to record an image with high precision that is corrected for positional misalignment between a recording medium and a recording head, in which marks for positioning are respectively provided relative to the conveying direction of the recording medium on the conveying direction upstream side and conveying direction downstream side, and positional detection is carried out by capturing each of the marks using each of the camera units of the alignment unit arranged to correspond with each of the marks for positioning, even when the marks on the upstream side and the downstream side are shifted relative to each other in the direction orthogonal to the conveying direction,.

A first aspect of the present invention is an image recording apparatus that, based on positional information of a recording medium detected in an outward movement process of moving a stage mounted with the recording medium, the recording medium having plural marks for reference, relative to an exposure head and to an alignment unit, carries out exposure processing by relatively moving the recording medium mounted on the stage with respect to the exposing head and the alignment unit in a homeward movement process, during exposing correction being made for relative positional alignment error between the exposing head and the recording medium, the image recording apparatus including: a first camera mounted via a movement adjusting mechanism on one face side portion of a base member of the alignment unit for capturing the position of a first of the marks provided on the recording medium; and a second camera mounted via a movement adjusting mechanism on the other face side portion of the base member of the alignment unit for capturing the position of a second of the marks for positioning shifted by a predetermined small distance in the direction orthogonal to the conveying direction relative to positions along the conveying direction from the first mark provided on the recording medium.

Another aspect of the present invention is an alignment unit for capturing plural reference marks on a recording medium moved relative to an image forming head, the alignment unit including: at least two cameras; at least two movement mechanisms for moving the respective at least two cameras in a direction that is orthogonal to the direction of relative movement, such that the at least two cameras are able to attain a positional relationship with at least a portion overlapping when viewed along the direction of relative movement; and a mechanism for measuring the position of each of the at least two cameras when they are in a halted state relative to the movement mechanism, and for carrying out correction of positional error; wherein the plural reference marks are captured by the at least two cameras that are in the halted state and have been corrected for positional error.

Other aspects, features and advantages of the present invention will become apparent from the following description taken in conjunction with the accompanying drawings.

### BRIEF DESCRIPTION OF THE DRAWINGS

Exemplary embodiments of the present invention will be described in detail based on the following figures, wherein:

FIG. 1 is a partially exploded perspective diagram showing the outline configuration of an exposing apparatus of an alignment unit of the present invention and an image recording apparatus using the same, according to an exemplary embodiment of the present invention;

FIG. 2 is a plan view showing regions that have completed exposure, formed on an exposure surface when exposing processing a recording medium in an exposing apparatus;

FIG. 3 is a main portion perspective diagram showing a state in which the alignment unit portion has been taken out of the exposing apparatus, as seen from the upstream side in the outward direction;

FIG. 4 is a main portion perspective diagram showing a state in which the alignment unit portion has been taken out of the exposing apparatus, as seen from the downstream side in the outward direction;

FIG. 5 is an explanatory diagram showing the relationship between marks placed on a recording medium and a camera for aligning the alignment unit in the exposing apparatus;

FIG. 6 is an explanatory diagram showing the relationship between marks and a shifted mark used for positioning arranged on a recording medium, and cameras for aligning the alignment unit in the exposing apparatus;

FIG. 7 is a plan view showing a positional relationship between a recording medium and cameras provided in the alignment unit of the exposing apparatus in a second exemplary embodiment of the present invention;

FIG. 8 is a plan view showing a positional relationship between a recording medium and cameras provided in the alignment unit of the exposing apparatus in a third exemplary embodiment of the present invention; FIG. 9 is a plan view showing a positional relationship between a recording medium and cameras provided in the alignment unit of the exposing apparatus in a forth exemplary embodiment of the present invention;

FIG. 10 is a plan view showing a positional relationship between a recording medium and cameras provided in the alignment unit of the exposing apparatus in a fifth exemplary embodiment of the present invention;

FIG. 11 is a plan view showing a positional relationship between a recording medium and cameras provided in the alignment unit of the exposing apparatus in a sixth exemplary embodiment of the present invention;

FIGS. 12A and 12B are diagrams showing a positional relationship of cameras provided in the alignment unit of the exposing apparatus in a seventh exemplary embodiment of the present invention.

### DETAILED DESCRIPTION

<Apparatus Body>

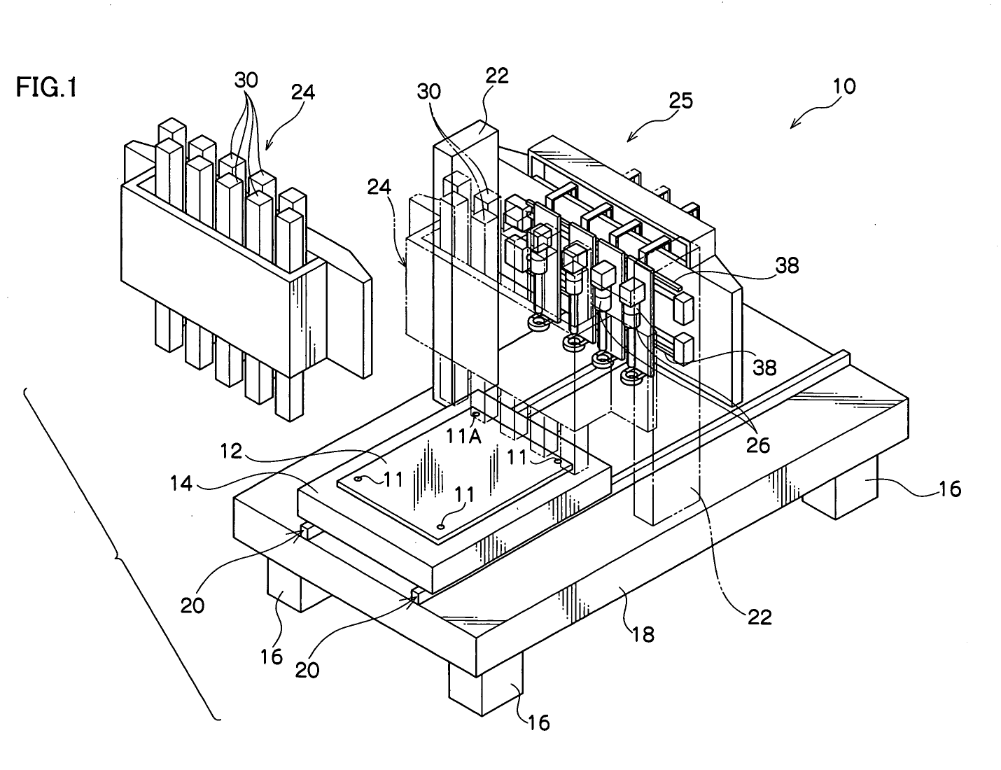

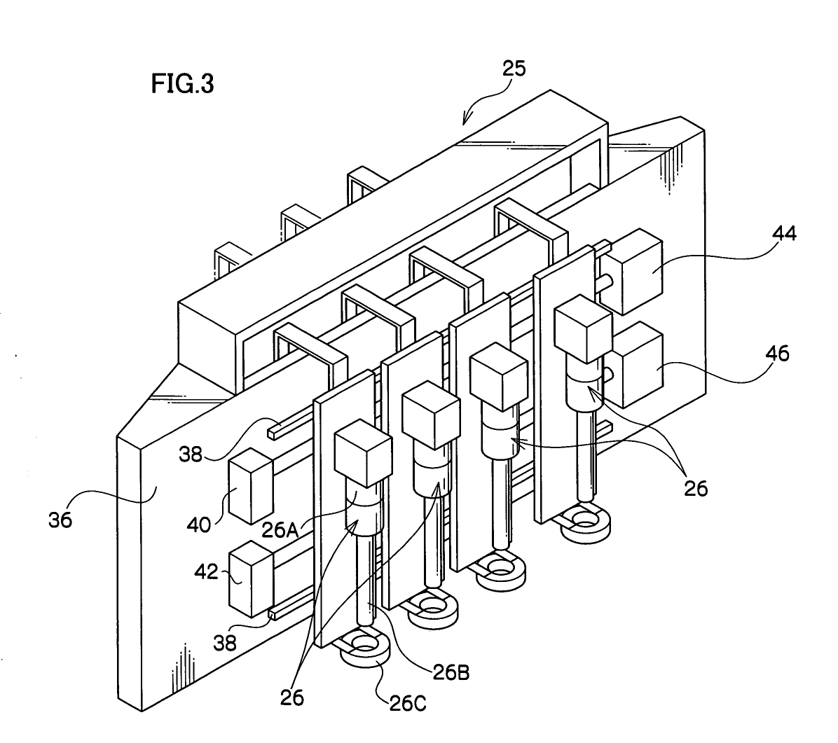

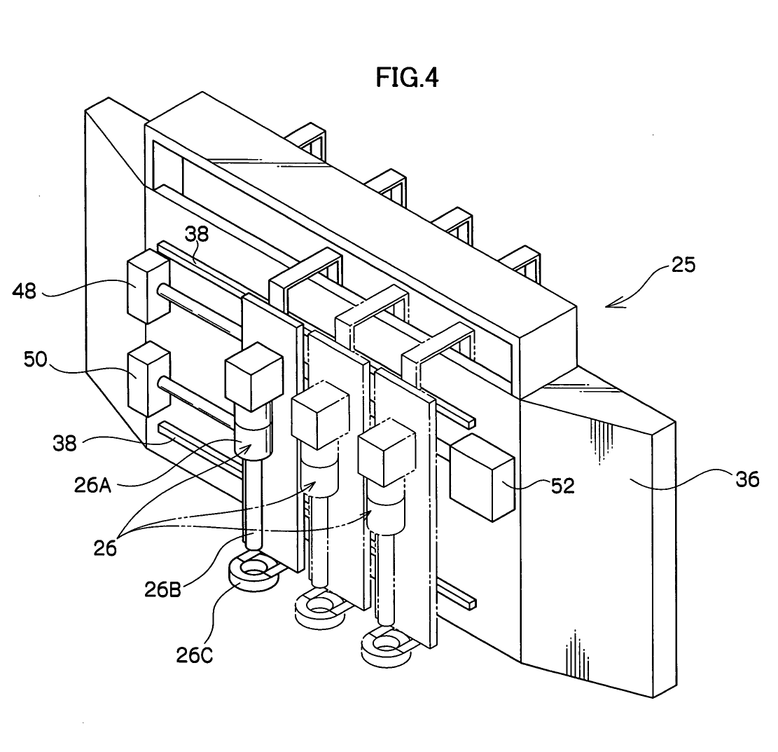

Explanation will be given, with reference to FIGS. 1 to 6, of an exemplary embodiment relating to an alignment unit of the present invention and an image recording apparatus using the same.

As shown in the outline perspective diagram of FIG. 1, the exposing apparatus 10 of the present exemplary embodiment may be configured as a flat bed multibeam exposing apparatus, drive controlled by an unillustrated control unit. Such an exposing apparatus 10 is configured to adhere and retain a recording medium 12 of an FPD substrate member or the like onto a flat surface of a moving stage 14, and exposing processing is carried out, while the recording medium 12 is moved by the moving stage 14 in a main scanning direction, by using exposing heads 30 installed in a scanner 24, by spatially modulating a multibeam that has been emitted, from a light source side according to a modulating signal generated from image data by a control unit, and irradiating the multibeam onto the recording medium 12.

In the exposing apparatus 10 there is a thick, plate-shaped installation base 18 supported by legs 16, and there are two elongated linear guide devices 20 placed along and extending in the stage movement direction. The moving stage 14 is set so as to have a length direction thereof facing in the stage movement direction, and also so as to be reciprocally moveable by the linear guide devices 20.

The exposing apparatus 10 is provided with a movement mechanism (unillustrated) of a linear motor or the like for moving the moving stage 14 in the stage movement direction (main scanning direction), and a linear encoder (unillustrated) for outputting a pulse signal along with the movement of the moving stage 14, and the exposing apparatus 10 is configured such that movement operations are precisely controllable by detecting the position information and scanning velocity of the moving stage 14 by detecting the pulse signal from the linear encoder. The moving stage 14 is configured so as to be able to define a position of the recording medium 12 on the upper surface of the moving stage 14 and carry out alignment.

In the exposing apparatus 10 there are gates 22 standing up on each side of the movement path of the moving stage 14 at a central portion of the installation base 18. The scanner 24 is disposed on the gates 22 so as to bridge across on one side of the gates 22 in the longitudinal direction with respect to the stage movement direction, and an alignment unit 25, mounted with plural cameras 26 as positional detecting mechanisms for detecting marks provided on the recording medium 12, is disposed spanning across the gates 22 at the other side in the longitudinal direction.

The exposing apparatus 10 configured such that the scanner 24 and the cameras 26 are disposed at predetermined positions above the movement path of the moving stage 14, with the scanner 24 disposed on the upstream side in the outward direction (outward direction near side) and with the cameras 26 disposed on the downstream side in the outward direction (outward direction far side) relative to the gates 22.

In the exposing apparatus 10 one exposing processing operation is carried out by the moving stage 14 being moved out and returned. That is, in the exposing apparatus 10: positional information of the recording medium 12 mounted on the moving stage 14 is obtained by the alignment unit 25 in an outward movement process in which the moving stage 14 mounted with the recording medium 12 is moved from the initial position through, below the scanner 24 and the alignment unit 25 to the movement final position; processing is carried out correcting for the relative positional errors between the scanner 24 and the recording medium 12 based on the positional information; and then scanning exposure processing is carried out by the scanner 24 during a homeward operation of moving the moving stage 14 from the movement final position to the initial position.

The recording medium 12 that is the object of exposure processing in the exposing apparatus 10 is disposed, in predetermined positions, with positioning marks 11 for use in detecting the position by being captured by the cameras 26 of the alignment unit 25. The recording medium 12 used in the exposing apparatus 10 is configured with positioning marks 11 as through holes, and at the positions of three of the apexes of the four apexes of the writable square or rectangle on the recording medium 12, through holes are perforated as positioning marks 11, and at the remaining apex position a through hole as a shifted positioning mark 11A is perforated at a predetermined shifted position that is moved by a predetermined distance along one edge of the square or rectangle from the position of the apex.

With the recording medium 12, provided with such positioning marks 11 formed by perforating through holes at three of the positions of the apexes of such a quadrangle and provided with the shifted positioning mark 11A, when the recording medium is held in the hand of an operator, by mounting the recording medium 12 on the recording stage in the state in which the shifted positioning mark 11A is at a predetermined one corner of the four corners, at the left and right sides of the front and back, (for example the near left corner), mounting operation can easily be carried out with the trailing edge of the recording medium 12 unambiguously in the correct set state at the rear end side of the moving stage 14 with the front face of the recording medium 12 (the recording face) to the top.

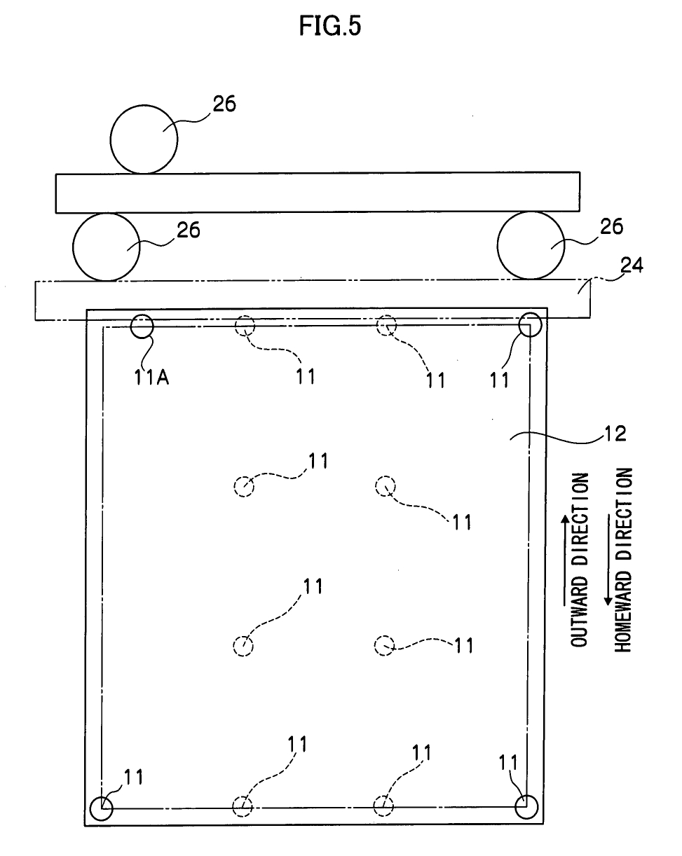

The recording medium 12, when applied to carrying out exposure processing by dividing each sheet of the recording medium 12 into 9 parts and carrying out correction processing for positional errors for each of the parts, as shown by the dotted lines in FIG. 5, through holes are perforated for the positioning marks 11 at each of the four corners of the 9 parts it is divided into. Here, when applied to carrying out exposure processing by dividing each sheet of recording medium 12 into a predetermined number of parts that is less than 9 parts and carrying out correction processing for positional errors for each of the parts, perforations of through holes may be made for the positioning marks 11 at the predetermined positions of the four corners of the predetermined number of parts the sheet is divided into.

In order to capture and detect the position of the positioning marks 11 and the shifted positioning mark 11A provided in such a manner on the recording medium 12, the alignment unit 25 is configured as shown in the FIGS. 1, 3 and 4.

<Alignment Unit>

In the alignment unit 25 there are: four cameras 26 mounted (depending on the requirements five or more cameras may be mounted) via a movement adjustment mechanism on the upstream side face portion in the outward direction (on the initial position side of the moving stage 14 in the conveying direction) of a thick plate base member 36 spanning along a direction orthogonal to the conveying direction between the pair of gates 22; and there are a necessary number of at least one or more cameras 26 mounted via a movement adjustment mechanism on the outward direction downstream side (movement final position side of the moving stage 14 in the conveying direction) of the base member 36.

The cameras 26 are configured with a lens portion 26B protruding from a camera body 26A, so that the front end portion of the lens portion 26B looks out through the space in the center of the ring of a ring-shaped strobe light source (LED strobe light source) 26C.

In such a configuration of camera 26, when the strobe light source 26C is caused to emit light, the light is irradiated onto the recording medium 12 mounted on the moving stage 14, and the reflected light therefrom enters from the lens portion 26B and is input to the camera body 26A, thereby capturing the predetermined positioning marks 11 or shifted positioning mark 11A on the recording medium 12.

For the cameras 26, it is sufficient as long as the cameras 26 are able to capture the small positioning marks 11 or shifted positioning mark 11A, and the cameras 26 normally have narrow fields and are inexpensive. Therefore, in the alignment unit 25, in order that the cameras 26 with a narrow field are able to capture the predetermined positioning mark 11 or shifted positioning mark 11A the movement adjustment mechanism is configured such that the cameras 26 may be moved to, and retained in, positions corresponding to vertically above where the predetermined positioning mark 11 or shifted positioning mark 11A should be.

In the alignment unit 25, there is a pair of mutually parallel guide rails 38 disposed on each of the faces of the base member 36, for configuring the movement adjustment mechanism. The pair of guide rails 38 provided on the face on the outward direction upstream side of the base member 36 is slidably mounted with 4 cameras 26, and the pair of guide rails 38 provided on the face on the outward direction downstream side of the base member 36 is slidably mounted with 3 cameras 26.

Furthermore, in the alignment unit 25, so that each of the cameras 26 may be independently movement adjustable, the base member 36 is mounted with ball screw feed assemblies 40, 42, 44, 46, 48, 50, and 52, for carrying out feeding actuation of each of the cameras 26, and spanning from the center of the side faces of the base member 36 across to respective portions on the two edge portions of the side faces of the base member 36.

In the alignment unit 25 of such a configuration, by controlling the driving of the ball thread feed assembly 40, 42, 44, 46, 48, 50, or 52 corresponding to the desired camera 26, moves the desired camera 26 to a position corresponding to vertically above where the predetermined positioning mark 11 or shifted positioning mark 11A should be, and sets the camera 26 retained in that position so that it does not move.

Also, in the alignment unit 25, the coordinate positions of each of the cameras 26 set in the capturing position are measured and information on positional errors is detected. This information on positional errors is used when executing correction processing of relative positional errors between the scanner 24 and the recording medium 12, is executed out by a unit for carrying out positional errors correction processing.

In the alignment unit 25 it is necessary to specify the positional information of each of the camera 26 to micro order precision. In order to do this, during the operation of exposure processing of the recording medium 12 the cameras 26 mounted on the alignment unit 25 are maintained in a stopped condition, since if the ball thread feed assemblies 40, 42, 44, 46, 48, 50, and 52 were feed actuated during the operation of exposure processing of the recording medium 12 it would become impossible to specify the positional information of the set positions of the camera 26 with micro order precision.

In the alignment unit 25, when, relative to the conveying direction of the recording medium 12, on the conveying direction downstream side of a conveying direction upstream side positioning mark 11, there is the positioning mark 11A which has been shifted by a short predetermined distance in the direction orthogonal to the conveying direction, or when there is a positioning mark 11 on the conveying direction downstream side of the conveying direction upstream side shifted positioning mark 11A, then the camera 26 for detecting the positioning mark 11 and the camera 26 for detecting the shifted positioning mark 11A are separated and placed one on each side of the base member 36.

With such a configuration, even when the distance, in the direction orthogonal to the conveying direction, between the positioning mark 11 and the shifted positioning mark 11A is smaller than the distance between the fields of two of the cameras 26 when the two of the cameras 26 are arranged as close together as possible (when there are physical constraints on the positioning of two of the cameras 26 due to camera size), by arranging one of the cameras 26 on one side face of the base member 36 and the other of the cameras 26 on the other side face of the base member 36, the arrangement positions of the cameras 26 may be freely set with respect to the direction orthogonal to the conveying direction of the recording medium 12, and therefore each of the cameras 26 may be arranged in a state in which it is possible to capture the positioning mark 11 or the shifted positioning mark 11A.

With such a configuration, while not illustrated, even though it is necessary to have separate cameras for capturing two marks that are arranged in desired positions on the recording medium 12 that are close to each other, by arranging one of the cameras 26 on one side face of the base member 36 and the other of the cameras 26 on the other side face of the base member 36, capturing may be carried out setting a spacing that is small in practice between the cameras 26 in the direction orthogonal to the conveying direction.

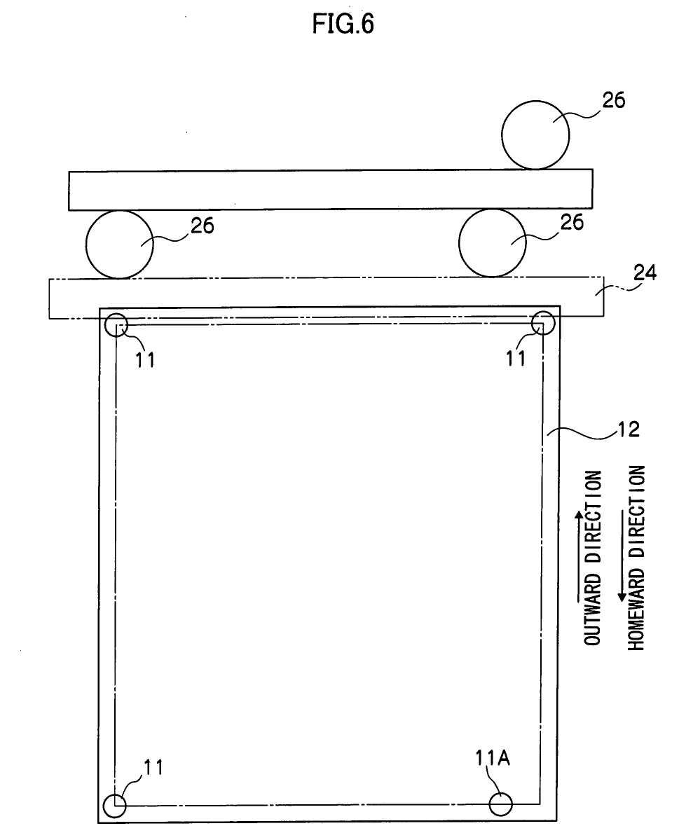

As shown in FIGS. 5 and 6, in the alignment unit 25, is configured such that the camera 26 for capturing and reading in the final positioning mark 11 or the shifted positioning mark 11A at the trailing edge side of the recording medium arranged on the outward direction upstream side of the recording medium 12 (the side of the end portion of the installation base 18 when the moving stage 14 is in the initial position) is arranged on the outward direction upstream side of the alignment unit 25 (the side of the initial position of the moving stage 14).

By such a configuration, in the exposing apparatus 10, when carrying out one exposure processing operation by reciprocating movement of the moving stage 14, the moving stage 14 mounted with the recording medium 12 starts moving from the initial position, and the movement final position may be set as the position when the final positioning mark 11 or shifted positioning mark 11A to be read, positioned at the outward direction upstream side of the recording medium 12, is captured by the camera 26 arranged at the outward direction upstream side on the alignment unit 25.

When set in such a manner, the reciprocating movement stroke of the moving stage moving stage 14 may be made as short as possible when carrying out exposure processing, the time required for obtaining the positional information of the recording medium 12 may be shortened, and the operating efficiency of exposure processing may be increased.

Furthermore, in the exposing apparatus 10, by making the reciprocating movement stroke of the moving stage 14 as short as possible when carrying out exposure processing, and overall length in the moving stage 14 in the movement direction of the installation base 18, a massive object that requires high rigidity, may be shortened to the smallest required limit, achieving compactness of the device as a whole, and a cost effective product may be provided.

When, in the alignment unit 25, the camera 26 for capturing the positioning mark 11 or the shifted positioning mark 11A that is disposed at the outward direction upstream side of the recording medium 12 is disposed at the outward direction downstream side of the alignment unit 25, then the positioning mark 11 or the shifted positioning mark 11A that is disposed at the outward direction upstream side of the recording medium 12 the moving stage 14 must be moved the extra distance to the outward direction downstream side camera for capture, after passing the camera 26 disposed on the outward direction upstream side in the alignment unit 25, so the reciprocating movement stroke of the moving stage 14 when carrying out exposure processing is lengthened, and this is a cause of reduced operating efficiency in exposure processing.

<Exposure Processing>

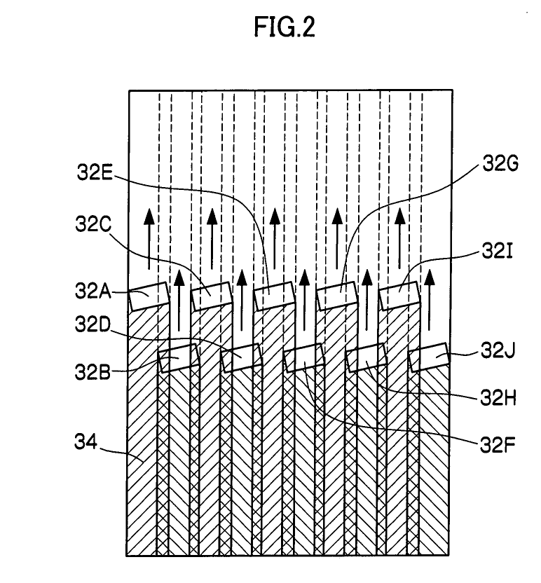

As shown in FIGS. 1 and 2, in the exposing apparatus 10 there is a scanner 24 disposed at the outward direction upstream side in the alignment unit 25. This scanner 24 is provided with ten exposing heads 30 arrayed substantially in a 2 by 5 matrix.

In the inside of each of the exposing heads 30 there is mounted a Digital Micro-mirror Device (DMD) that is a Spatial Light Modulator (SLM) for spatially modulating an incoming beam.

While not illustrated, the DMD is monolithic overall (integrated together), configured of a mirror device of lattice-shape arrayed micro mirrors that are plural (for example, 600×800) micro mirrors configuring pixels.

A material with high reflectance, such as aluminum, is vacuum deposited on the micro mirror surface arranged at the uppermost portion of each of the pixels. Furthermore, support columns protrude from the center of the bottom faces of each of the micro mirrors.

The DMD has base end portions of the support shafts protruding from micro-mirrors mounted to hinges provided corresponding to each of the respective pixels on an SRAM cell CMOS silicon gate manufactured on a standard semiconductor memory line, configured such that the micro-mirrors are mounted with the hinges as axes on the diagonals, and mounted so as to be able to incline by about ±10 degrees,.

The DMD is configured drive controllable such that, using electrostatic force due to accumulated charge at one side or the other of respective mirror address electrodes configured at the two end portions of the diagonal of the sloping micro-mirror on the SRAM, when the micro mirror is in the ON state it is in a condition of being angled at +10 degrees, or when the micro mirror is in the OFF state it is in a condition of being angled at −10 degrees.

In such a configuration of DMD, when a digital signal is read to the SRAM, each of the micro mirrors for the respective pixels of the DMD is controlled so as to be angled about the diagonal at +10 degrees to the side of the substrate on which the DMD is disposed when in the ON state, and at −10 degrees when in the OFF state, and light from the light source incident on the DMD is reflected in the angled directions of the respective micro mirrors according to the image signal.

Light reflected by micro mirrors in the ON state is modulated to the exposing state, and focused onto the recording medium by a projection optical system provided on the light output side of the DMD. Also, light reflected by micro mirrors in the OFF state is modulated to the non exposing state, and made incident to a light absorbing medium.

Each of the exposing heads 30 provided with such a DMD is, as shown in FIG. 2, disposed such that an exposing area 32 (32A to 32J) is a rectangular shaped (or a parallelogram shaped) area angled to the scanning direction. Then, accompanying the movement of the moving stage 14, by irradiating modulated light beams onto the recording medium 12 from each of the exposing heads 30 with the desired timing, strip-shaped exposed regions 34 are formed for each of the exposing areas 32 of the exposing heads 30. These strip-shaped exposed regions 34 are formed by dots corresponding to the micro mirror two-dimensional array of the DMD.

By disposing the DMD at an angle to the scanning direction in the above manner, the spacing between rows of exposing points in the direction orthogonal to the scanning direction may be made narrow, and high definition may be achieved.

Respective rows of the line arrayed exposing areas 32 (32A to 32J) are arranged so as to be staggered by a predetermined interval in the array direction, such that each of the strip-shaped exposed regions 34 partially overlaps with the adjacent strip-shaped exposed region(s) 34. Due to this, for example, the portion that cannot be exposed between the exposing area 32A positioned at the extreme left side of the first row and the exposing area 32C that is positioned adjacently at the right of the exposing area 32A, is exposed by the exposing area 32B positioned at the extreme left side of the second row. In the same way, the portion that cannot be exposed between the exposing area 32B and the exposing area 32D that is positioned adjacently at the right of the exposing area 32B, is exposed by the exposing area 32C.

Next, explanation will be given of the operation of exposing heads configured as above.

In the exposing apparatus 10 image data corresponding to the exposure pattern is input to a non illustrated control unit connected to the DMD, and temporarily stored in the control unit. This image data is data representing the density of each image pixel configuring an image by binary values (presence or not of a recording dot).

The recording medium 12, in a state of being attached to the surface of the moving stage 14, is moved in the scanning direction in the outward step of the moving stage 14. In the exposing apparatus 10, when the recording medium 12 passes under the exposing heads 30, the image data stored in the memory is read out in sequence, several line's worth at a time. A control signal (control data), corrected by the drawing position when exposing by the scanner 24, is generated by a control device as a data processing unit, based on the read out image data and correction data for correcting relative positional errors between the scanner 24 and the recording medium 12, according to the positional information of the recording medium 12 mounted on the moving stage 14 obtained by the alignment unit 25 in the outward step.

In the exposing heads 30 the respective micro mirrors of the DMD are ON-OFF controlled according to the generated control signal. When a laser beam is irradiated from a non illustrated light source unit to the DMD controlled in such a manner, when the micro mirrors of the DMD are in the ON state then the reflected laser beam is focused as a beam spot on the recording medium 12 and exposure is carried out.

By carrying out exposure by the exposing heads 30 while moving the recording medium 12 mounted on the moving stage 14 in the scanning direction, an image corrected for distortions in the image due to relative positional errors between the scanner 24 and the recording medium 12 is two-dimensionally exposed on the recording medium 12.

In the exposing apparatus 10 the exposure processing is concluded at the point when the predetermined image data has been exposed onto the recording medium 12, and the moving stage 14 is moved to the initial position again to await commencement of the next exposure processing.

Furthermore, in the image recording apparatus according to the present invention a DMD was used as a spatial modulator in the exposing heads 30, but in place of the DMD, for example, a Micro Electro Mechanical System (MEMS) type spatial modulator (Special Light Modulator (SLM)), an optical element (PLZT element) that modulates the transmission of light using the electro optical effect, or spatial modulators other than MEMS type, such as a liquid crystal shutter (FLC), or the like, may be used.

Also, the spatial modulator is not limited one that only can take ON/OFF states, and a spatial modulator that can express gradations, taking plural intermediate values in addition to ON/OFF states, may be used.

MEMS is used to refer to micro systems of integrated micro sized sensors, actuators, and control circuits, manufactured by micro machining techniques based on IC manufacturing processes, and MEMS type spatial modulators is used to refer to spatial modulators that are driven by electromechanical actuation using electrostatic force.

The multibeam exposure device according to the present exemplary embodiment may be configured by substituting means to selectively switch plural pixels between ON/OFF states in place of the DMD spatial modulators of the exposing heads 30. Means to selectively switch plural pixels between ON/OFF states may be, for example, laser beams that can be selectively switched between ON/OFF emittable states corresponding to the respective pixels, configured by laser beam light sources, or furthermore, by configuring a laser light source by disposing light emitting surfaces of each micro laser to correspond with each of the pixels to form a surface emitting laser, and selectively switching each micro laser emitting surface between ON/OFF emittable states.

<Camera Placement>

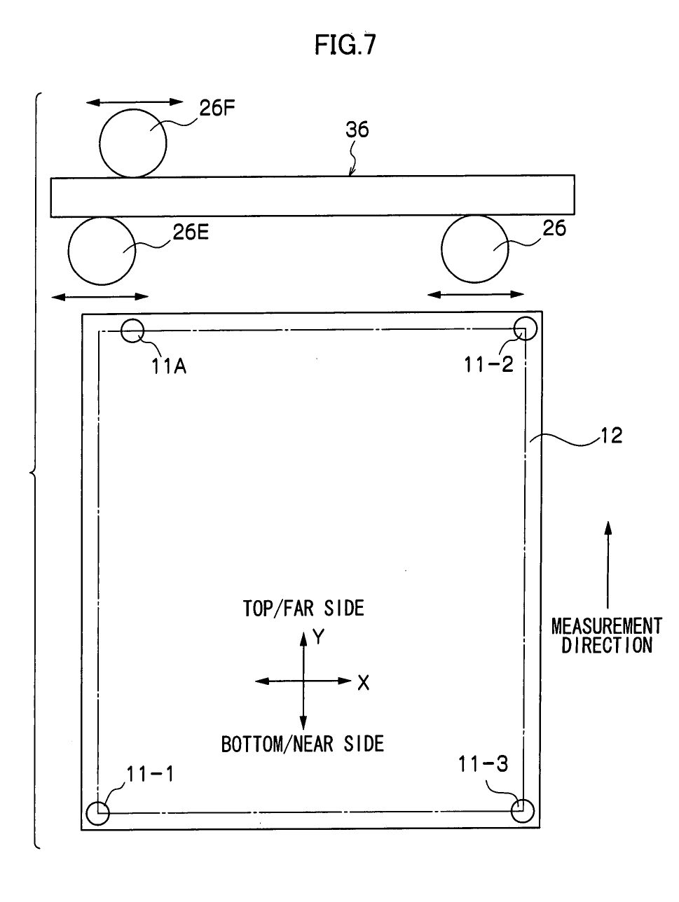

FIG. 7 shows the camera alignment according to a second exemplary embodiment of the present invention.

As shown in FIG. 7, there are plural cameras 26 provided at the base member 36 of the alignment unit 25, and, of these, there is a camera 26E that is provided at the conveying direction (direction of arrow Y in the figure) upstream side and a camera 26F that is provided at the conveying direction downstream side.

In order to distinguish the reverse face of the recording medium 12 the shifted positioning mark 11A is, relative to one of the positioning marks 11, position shifted in a direction (direction X in the figure) orthogonal to the conveying direction, and if it is attempted to read both the positioning mark 11 and the positioning mark 11A using, for example, a camera 26 positioned adjacent to camera 26E, then when the distance between the positioning mark 11 and the positioning mark 11A in the X direction is smaller than the distance between the two fields of two neighboring cameras 26, then there is the problem that one of the marks might not fall within the field of one of the cameras.

Therefore, as described above, by staggering the plural cameras 26E/26F in the Y direction, and making it such that the positioning marks 11, 11A are each read by respective cameras 26E/26F, even when the distance between the positioning marks 11/11A gets small, reading problems may be avoided.

In addition, in the figure the positioning mark 11-1 provided at the conveying direction upstream side (bottom/near side in the figure) may be read by the conveying direction upstream side camera 26E, and the positioning mark 11A provided at the downstream side (top/far side in the figure) may be read by the downstream side camera 26F, and processing time may be reduced.

That is, since from reading the conveying direction downstream side positioning mark 11A with the camera 26F, till reading the conveying direction upstream side positioning mark 11-1 with the camera 26E, for conveying the recording medium 12 in the Y direction is the position reading process, the movement distance of the recording medium 12 is shorter than if the cameras 26 for reading the positioning marks 11/11A were arrayed on a straight line in the X direction, effectively enabling the processing time to be shortened.

Or, as shown in FIG. 6, the cameras 26 at the opposite side end (in the X direction) of the base member 36 to those of FIG. 7 may be positioned staggered. Further, pairs of cameras at each end in the X direction may be provided staggered in the Y direction.

Furthermore, even when placement of the cameras 26 such as the above is adopted, when the staggering in the X direction of the positioning marks 11/11A is to the extend that one camera 26 is able to cover, by capturing the positioning marks 11/11A using only the camera 26 at the near side (upstream side, bottom of the figure) there is a reduce movement distance of the moving stage 14 when capturing, and the processing time may be reduced.

<Camera and Mark Placement>

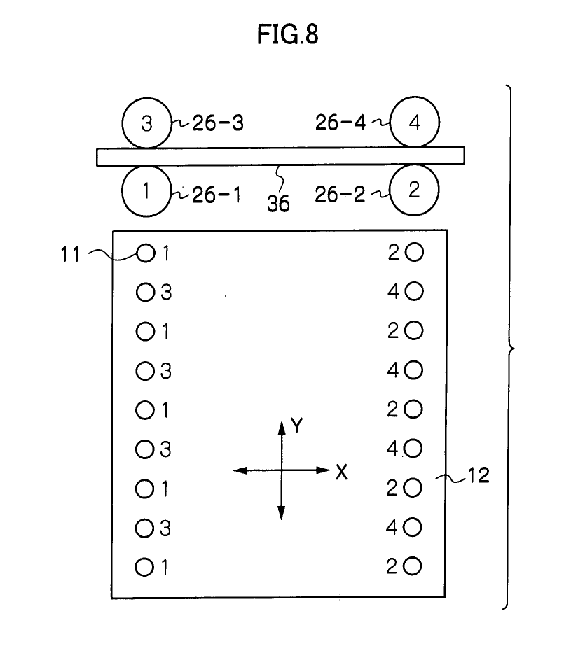

FIG. 8 shows camera placement of an alignment unit according to a third exemplary embodiment of the present invention.

As shown in FIG. 8, there are plural cameras 26 provided at the base member 36 of the alignment unit 25, and, of these, there are cameras 26-1, 26-2 that are provided at the conveying direction (direction of arrow Y in the figure) upstream side and cameras 26-3, 26-4 that are provided at the conveying direction downstream side.

By capturing in sequence plural positioning marks 11 provided on the recording medium 12 using plural arrayed cameras 26 in the above manner, without changing the time taken in the cameras 26 for image processing when capturing, the placement pitch of the positioning marks 11 in the measurement direction (the top-bottom direction in the figures) may be shortened. That is, even when the placement pitch of the positioning marks 11 is changed, the measurement speed may be maintained.

FIG. 9 shows camera placement in an alignment unit of a fourth exemplary embodiment of the present invention.

As shown in FIG. 9, there are plural cameras 26 provided at the base member 36 of the alignment unit 25, and, of these, there are cameras 26-1, 26-2 that are provided at the conveying direction (direction of arrow Y in the figure) upstream side and cameras 26-3, 26-4 that are provided at the conveying direction downstream side.

By capturing a plural number of times the plural positioning marks 11 provided on the recording medium 12 using plural arrayed cameras 26 in the above manner, the capturing precision of the cameras 26 is increased. That is, the same positioning mark 11 is captured plural times (two times in the figure) by plural cameras (two in the figure), and, therefore, the precision of the data as a whole may be increased due to the averaging effect.

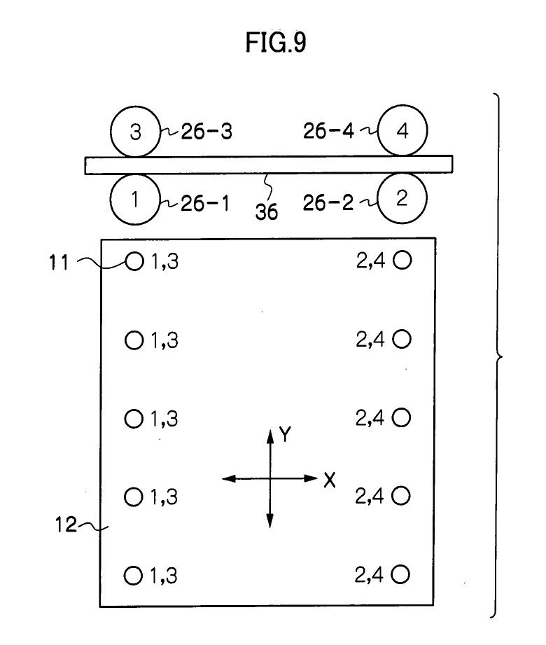

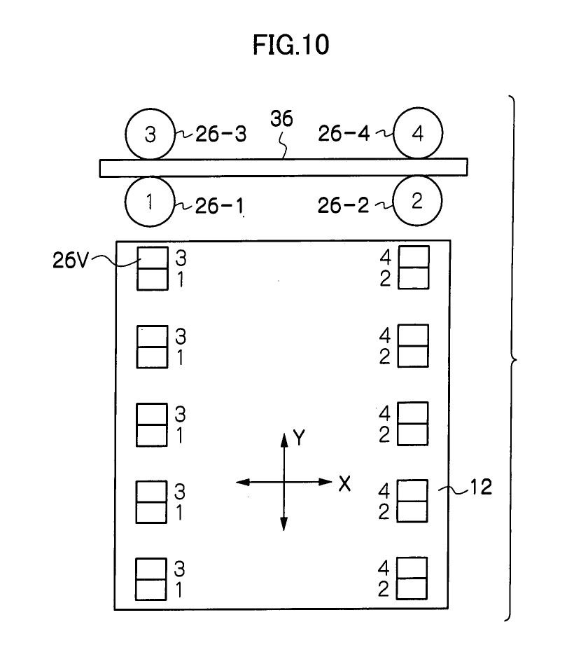

FIG. 10 shows camera placement in an alignment unit of a fifth exemplary embodiment of the present invention.

As shown in FIG. 10, there are plural cameras 26 provided at the base member 36 of the alignment unit 25, and, of these, there are cameras 26-1, 26-2 that are provided at the conveying direction (direction of arrow Y in the figure) upstream side and cameras 26-3, 26-4 that are provided at the conveying direction downstream side.

The fields 26V of the plural arrayed cameras 26 provided in the above manner are arranged such that they are the same in the camera 26 X direction, and, as shown in the figure, formed adjacent in the conveying direction (the top-bottom direction in the figure). By doing so, the fields are expanded (in the figure by two times) in the conveying direction (the top-bottom direction in the figure), it becomes difficult for a positioning mark 11 to escape the fields, and therefore the success rate of capturing is increased, and by decreasing the number of re-try times the processing time may be shortened.

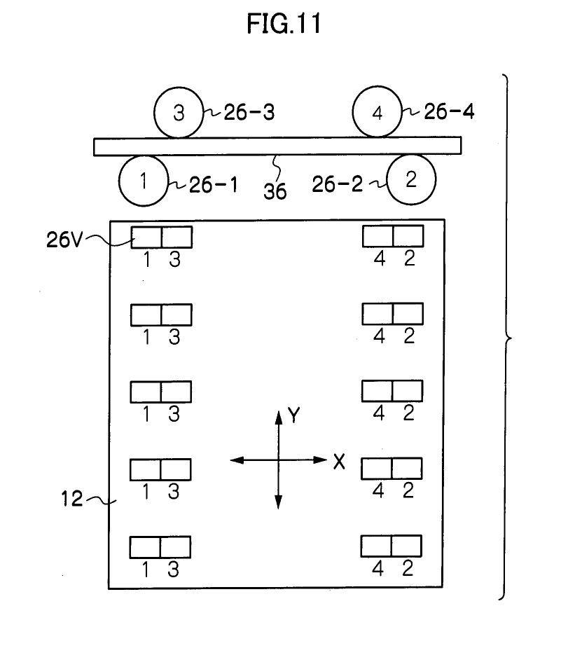

FIG. 11 shows camera placement in an alignment unit of a sixth exemplary embodiment of the present invention.

As shown in FIG. 11, there are plural cameras 26 provided at the base member 36 of the alignment unit 25, and, of these, there are cameras 26-1, 26-2 that are provided at the conveying direction (direction of arrow Y in the figure) upstream side and cameras 26-3, 26-4 that are provided at the conveying direction downstream side, as was the case with the third embodiment, however, the cameras 26-1/3 and 26-2/4 are arranged mutually shifted in the X direction.

Since the fields 26V of the plural arrayed cameras 26 provided in the above manner are shifted in the camera 26 X direction, they are formed adjacent in the X direction (left-right direction in the figure). By doing so, the fields are expanded (in the figure by two times) in the X direction (the left-right direction in the figure), and it becomes difficult for a positioning mark 11 to escape the fields, and therefore the success rate of capturing is increased, and by decreasing the number of re-try times the processing time may be shortened.

<Arrangement of the Camera and Capture Elements)

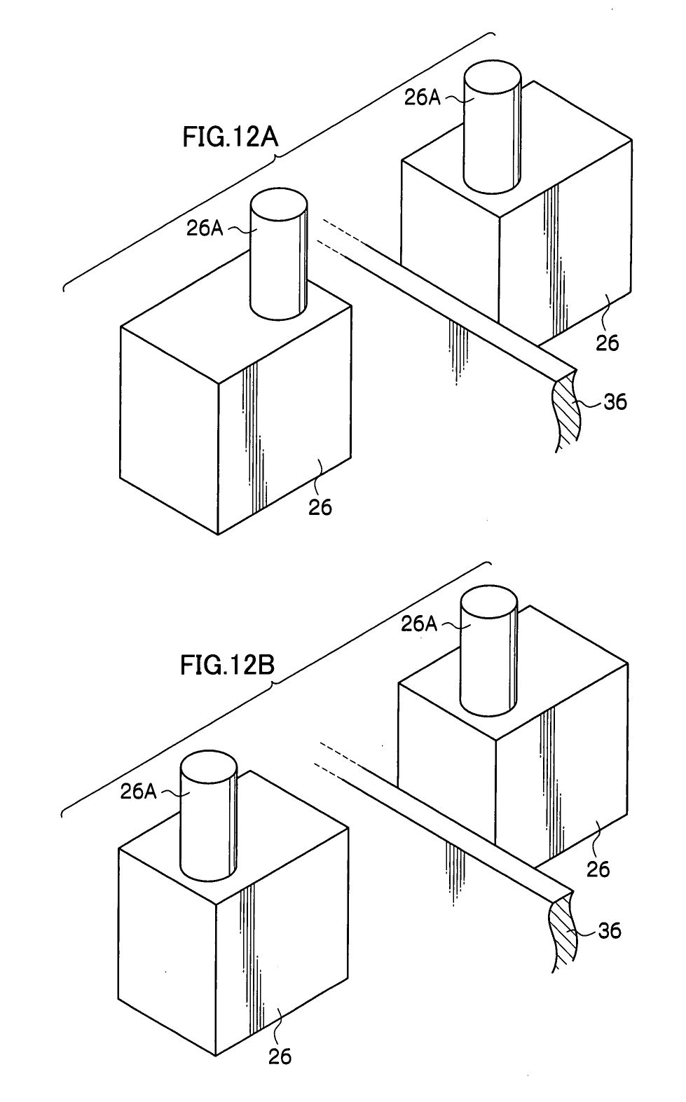

FIG. 12 shows camera placement in an alignment unit of a seventh exemplary embodiment of the present invention.

As is shown in FIG. 12A, in the cameras 26 provided on both sides of the base member 36, the position of the camera bodies 26A are in the direction of facing each other, for convenience of mounting or the like. In this case, since the images captured with the respective cameras 26 face in mutually opposite directions, in order to arrange them both in the same direction it is necessary to rotate one of the images by 180°, and time for image rotation in image processing is required.

In the present exemplary embodiment, as shown in FIG. 12B, in the cameras 26 provided on both sides of the base member 36, the camera bodies 26A are provided in the position so as to face in the same direction as each other, such that the fields thereof face in the same direction.

By doing so, the captured images obtained by each of the cameras 26 are aligned at the capturing stage, and so there is no need for the images to be rotated in image processing, and the time necessary for image processing may be curtailed.

As may be understood from the above explanation, according to the alignment unit of the present invention and to the image recording apparatus using such an alignment unit, by providing, relative to the conveying direction of a recording medium, marks for positioning on respectively the conveying direction upstream side and conveying direction downstream side that are arranged relatively shifted with respect to each other in the direction orthogonal to the conveying direction, and, at the apparatus body side, by capturing with each of the camera units of the alignment unit, arranged to correspond to each of the marks for positioning, each of the corresponding marks for positioning and undertaking position detection of each, there is the effect that an image of high precision may be recorded, corrected for positional misalignment between the recording medium and the recording head.

1. An image recording apparatus that, based on positional information of a recording medium detected in an outward movement process of moving a stage having the recording medium mounted thereon, the recording medium having a plurality of marks for reference, relative to an exposure head and to an alignment unit, carries out exposure processing by relatively moving the recording medium mounted on the stage with respect to the exposing head and the alignment unit in a homeward movement process, during exposing correction being made for relative positional alignment error between the exposing head and the recording medium, the image recording apparatus comprising:
a first camera mounted via a movement adjusting mechanism on one face side portion of a base member of the alignment unit for capturing the position of a first of the marks provided on the recording medium; and
a second camera mounted via a movement adjusting mechanism on the other face side portion of the base member of the alignment unit for capturing the position of a second of the marks for positioning shifted by a predetermined small distance in the direction orthogonal to the conveying direction relative to positions along the conveying direction from the first mark provided on the recording medium.

2. The image recording apparatus according to claim 1, wherein the camera for capturing the first mark or the shifted second mark for positioning that is at the trailing edge side of the recording medium and is the last to be read in the outward movement process, is the camera arranged on the outward direction upstream side of the base member.

3. The image recording apparatus according to claim 1, wherein at least one of
the plurality of cameras is arranged on the conveying direction upstream side and the other is shifted to the conveying direction downstream side, and shifted in a direction orthogonal to the conveying direction.

4. The image recording apparatus according to claim 2, wherein at least one of the plurality of cameras is arranged on the conveying direction upstream side and the other is shifted to the conveying direction downstream side, and shifted in a direction orthogonal to the conveying direction.

5. An alignment unit for capturing a plurality of reference marks on a recording medium moved relative to an image forming head, the alignment unit comprising:
at least two cameras;
at least two movement mechanisms for moving the respective at least two cameras in a direction that is orthogonal to the direction of relative movement, such that the at least two cameras are able to attain a positional relationship with at least a portion overlapping when viewed along the direction of relative movement; and
a mechanism for measuring the position of each of the at least two cameras when they are in a halted state relative to the movement mechanism, and for carrying out correction of positional error; wherein
the plurality of reference marks are captured by the at least two cameras that are in the halted state and have been corrected for positional error.

6. The alignment unit according to claim 5, wherein at least one of the plurality of cameras provided is at the conveying direction upstream side and at least one of the plurality of cameras provided is placed shifted toward the conveying direction downstream side and also shifted in a direction orthogonal to the conveying direction.

7. An image recording apparatus according to claim 1, wherein the alignment unit comprises:
at least two cameras,
at least two movement mechanisms for moving the respective at least two cameras in a direction that is orthogonal to the direction of relative movement, such that the at least two cameras are able to attain a positional relationship with at least a portion overlapping when viewed along the direction of relative movement: and
a mechanism for measuring the position of each of the at least two cameras when they are in a halted state relative to the movement mechanism, and for carrving out correction of positional error; wherein
the plurality of reference marks are captured by the at least two cameras that are in the halted state and have been corrected for positional error.

8. An image recording apparatus according to claim 2, wherein the alignment unit comprises:
at least two cameras:
at least two movement mechanisms for moving the respective at least two cameras in a direction that is orthogonal to the direction of relative movement, such that the at least two cameras are able to attain a positional relationship with at least a portion overlapping when viewed along the direction of relative movement; and
a mechanism for measuring the position of each of the at least two cameras when they are in a halted state relative to the movement mechanism and for carrying out correction of positional error; wherein
the plurality of reference marks are captured by the at least two cameras that are in the halted state and have been corrected for positional error.

9. An image recording apparatus according to claim 3, wherein the alignment unit comprises:
at least two cameras;
at least two movement mechanisms for moving the respective at least two cameras in a direction that is orthogonal to the direction of relative movement, such that the at least two cameras are able to attain a positional relationship with at least a portion overlapping when viewed along the direction of relative movement; and
a mechanism for measuring the position of each of the at least two cameras when they are in a halted state relative to the movement mechanism and for carrying out correction of positional error; wherein
the plurality of reference marks are captured by the at least two cameras that are in the halted state and have been corrected for positional error.

10. An image recording apparatus according to claim 4, wherein the alignment unit comprises:
at least two cameras;
at least two movement mechanisms for moving the respective at least two cameras in a
direction that is orthogonal to the direction of relative movement, such that the at least two cameras are able to attain a positional relationship with at least a portion overlapping when viewed along the direction of relative movement; and
a mechanism for measuring the position of each of the at least two cameras when they are in a halted state relative to the movement mechanism, and for carrying out correction of positional error; wherein
the plurality of reference marks are captured by the at least two cameras that are in the halted state and have been corrected for positional error.

11. An image recording apparatus according to claim 1, wherein the alignment unit comprises:
at least two cameras;
at least two movement mechanisms for moving the respective at least two cameras in a direction that is orthogonal to the direction of relative movement, such that the at least two cameras are able to attain a positional relationship with at least a portion overlapping when viewed along the direction of relative movement; and
a mechanism for measuring the position of each of the at least two cameras when they are in a halted state relative to the movement mechanism, and for carrying out correction of positional error; wherein the plurality of reference marks are captured by the at least two cameras that are in the halted state and have been corrected for positional error; and
wherein at least one of the plurality of cameras provided is at the conveying direction upstream side and at least one of the plurality of cameras provided is placed shifted toward the conveying direction downstream side and also shifted in a direction orthogonal to the conveying direction.

12. An image recording apparatus according to claim 2, wherein the alignment unit comprises:
at least two cameras;
at least two movement mechanisms for moving the respective at least two cameras in a direction that is orthogonal to the direction of relative movement, such that the at least two cameras are able to attain a positional relationship with at least a portion overlapping when viewed along the direction of relative movement; and
a mechanism for measuring the position of each of the at least two cameras when they are in a halted state relative to the movement mechanism, and for carrying out correction of positional error; wherein
the plurality of reference marks are captured by the at least two cameras that are in the halted state and have been corrected for positional error; and
wherein at least one of the plurality of cameras provided is at the conveying direction upstream side and at least one of the plurality of cameras provided is placed shifted toward the conveying direction downstream side and also shifted in a direction orthogonal to the conveying direction.

13. An image recording apparatus according to claim 3, wherein the alignment unit comprises:
at least two cameras;
at least two movement mechanisms for moving the respective at least two cameras in a direction that is orthogonal to the direction of relative movement, such that the at least two cameras are able to attain a positional relationship with at least a portion overlapping when viewed along the direction of relative movement; and
a mechanism for measuring the position of each of the at least two cameras when they are in a halted state relative to the movement mechanism, and for carrying out correction of positional error; wherein
the plurality of reference marks are captured by the at least two cameras that are in the halted state and have been corrected for positional error; and
wherein at least one of the plurality of cameras provided is at the conveying direction upstream side and at least one of the plurality of cameras provided is placed shifted toward the conveying direction downstream side and also shifted in a direction orthogonal to the conveying direction.

14. An image recording apparatus according to claim 4, wherein the alignment unit comprises:
at least two cameras;
at least two movement mechanisms for moving the respective at least two cameras in a direction that is orthogonal to the direction of relative movement, such that the at least two cameras are able to attain a positional relationship with at least a portion overlapping when viewed along the direction of relative movement; and
a mechanism for measuring the position of each of the at least two cameras when they are in a halted state relative to the movement mechanism, and for carrying out correction of positional error; wherein
the plurality of reference marks are captured by the at least two cameras that are in the halted state and have been corrected for positional error; and
wherein at least one of the plurality of cameras provided is at the conveying direction upstream side and at least one of the plurality of cameras provided is placed shifted toward the conveying direction downstream side and also shifted in a direction orthogonal to the conveying direction.
